(19) United States
(12) Patent Application Publication
(10) Pub. No.: US 2022/0151456 A1
(43) Pub. Date: May 19, 2022

(54) AUTOMATIC DISHWASHING METHOD WITH ALKALINE RINSE

(71) Applicant: The Procter & Gamble Company, Cincinnati, OH (US)

(72) Inventors: Lindsay Suzanne BEWICK, Tyne & Wear (GB); Patrick Firmin August DELPLANCKE, STEENHUIZE-WIJNHUIZE (BE); Katrien Andrea Lieven VAN ELSEN, LIEZELE-DORP 59/2 PUURS (BE)

(21) Appl. No.: 17/519,609

(22) Filed: Nov. 5, 2021

(30) Foreign Application Priority Data
Nov. 17, 2020 (US) PCT/US2020/070796

(51) Int. Cl. A47L 15/42; A47L 15/00

(52) U.S. Cl. CPC A47L 15/4231; A47L 15/0028; A47L 15/0026

(57) ABSTRACT

A method of cleaning dishware in a domestic dishwasher using a program including a cleaning cycle and a rinse cycle is described. The method includes the steps of a) placing the dishware in the dishwasher; b) delivering a cleaning composition having enzymes into the cleaning cycle to form a wash liquor and subjecting the dishware to the wash liquor; and c) delivering a rinse composition free of enzymes and free of bleach into the rinse cycle to form a rinse liquor having a pH of greater than 9 and subjecting the dishware to the rinse liquor.

### FIELD OF THE INVENTION

The present invention is in the field of automatic dishwashing. In particular, it relates to a method to provide improved cleaning, more in particular enzymatic cleaning while at the same time providing grit prevention and providing shine. The method also allows for an improvement in energy efficiency of the dishwashing process.

### BACKGROUND OF THE INVENTION

The automatic dishwashing detergent formulator is continuously looking for ways to improve the performance of automatic dishwashing, in terms of cleaning and finishing.

A frequent problem found in automatic dishwashing is the presence of grit on washed items. Grit is sometimes found on dishware/tableware after the automatic dishwashing process even if the items were free of it before they went into the dishwasher. It seems that grit is formed during the dishwashing process. The mechanism of grit formation is not well understood. It might be due to the high temperatures and combination of different soils, including oily soils, lifted from the soiled items during the dishwashing process. Somehow, different soils seem to recombine to give rise to grit which are small particles that deposit onto the surface of the washed items. Once the grit is formed and deposited it is very difficult to remove it.

There is a constant drive to make automatic dishwashing more environmentally friendly by reducing the amount of water, time and/or energy required by the automatic dishwashing process. It is an objective of the present invention to provide a method of dishwashing that provides improved cleaning, in particular improved removal of proteinaceous soils, such as meat, egg and dairy products and at the same time provides good shine and grit prevention.

It is another objective of the invention to provide a more energy efficient automatic dishwashing method.

### SUMMARY OF THE INVENTION

According to the first aspect of the invention, there is provided a method of cleaning dishware in a domestic dishwasher. The method uses a dishwashing program comprising a cleaning cycle and a rinse cycle. The method comprises the following steps:
a) placing the dishware in the dishwasher;
b) delivering a cleaning composition comprising enzymes into the cleaning cycle to form a wash liquor and subjecting the dishware to the wash liquor; and
c) delivering an alkaline rinse composition free of enzymes and free of bleach into the rinse cycle to form a rinse liquor having a pH of greater than 9 and subjecting the dishware to the rinse liquor.

The method of the invention provides improved enzymatic cleaning, in particular proteinaceous soils removal and at the same time provides improved shine and prevents grit formation.

According to the second aspect of the invention, there is provided a rinse composition suitable for use in the method of the invention. According to the third aspect of the invention, there is provided an automatic dishwashing pack suitable for use in the method of the invention. According to further aspects of the invention, there is provided the use of the method of the invention to provide proteinaceous soil removal and there is also provided the use of the rinse composition of the invention to provide shine and grit prevention in low temperature rinse programs.

The elements of the first aspect of the invention apply mutatis mutandis to the subsequent aspects of the invention.

### DETAILED DESCRIPTION OF THE INVENTION

The present invention encompasses a method of washing dishware in a dishwasher, a composition suitable for use in the method of the invention, a pack to accommodate a cleaning and a rinse composition for use in the method of the invention, the use of the composition to improve proteinaceous soil removal and the use of the composition in a low temperature rinse program to provide grit prevention and shine. The method of the invention takes place in a domestic dishwasher.

Automatic dishwashing machines may be domestic or commercial/institutional machine types. Generally, the differences are in terms of size, volume of throughput and duration of the dishwashing process. This can mean the machines are designed in very different ways. Industrial/institutional machines often have much shorter but more energy intensive (e.g. higher temperature) cycles compared to domestic machines, and/or use much more aggressive chemistry. Typically, they will not use enzymes, because these need a certain contact time with the treated soils to perform effectively, and the commercial cycle time is too short. In the case of commercial dishwashers, the machines can be based on a conveyor system in which dishware is moved through a single or multiple tanks of the dishwasher, whereas in domestic machines the dishware will generally always remain stationary in one tank inside the dishwasher, and all the washing steps will occur in that single tank. In domestic dishwashing, it is conventional to include bleaches and enzymes in the detergent.

“Dishware” herein means cookware, dishware and tableware, i.e. all items related to cooking and serving food and drinks that are usually washed in a dishwasher.

As used herein, the articles including “a” and “an” are understood to mean one or more of what is claimed or described. Unless otherwise noted, all component or composition levels are in reference to the active portion of that component or composition, and are exclusive of impurities, for example, residual solvents or by-products, which may be present in commercially available sources of such components or compositions. Unless specifically stated or the context otherwise requires, embodiments described herein apply equally to all aspects of the invention. Percentages quoted are by weight, unless otherwise stated or the context otherwise requires.

All measurements are performed at 25° C. unless otherwise specified.

### METHOD OF INVENTION

The method of the invention comprises the following steps to be performed in a domestic dishwasher:
a) placing the dishware in the dishwasher;
b) delivering a cleaning composition into the cleaning cycle to form a wash liquor and subjecting the dishware to the resulting wash liquor; and
c) delivering an alkaline rinse composition into the rinse cycle to form a rinse liquor and subjecting the dishware to the resulting alkaline rinse liquor.

The cleaning cycle takes place before the rinse cycle. The wash liquor can be discharged before introducing fresh water to form the rinse liquor. Alternatively, the rinse liquor can be formed by adding the rinse composition to the wash liquor.

The method of the invention can optionally have an intermediate rinse between steps b) and c) and/or a final rinse after step c). The liquor of the intermediate rinse can be discharged or left for the subsequent rinse.

The cleaning composition comprises enzymes and is preferably alkaline. Without wishing to be bound by theory, it is believed that enzymes from the cleaning composition are carried over from the cleaning cycle to the rinse cycle, even if the water is discharged at the end of the cleaning cycle, part of the ingredients of the cleaning liquor stays on the dishware. The alkaline rinse liquor promotes the enzymatic cleaning in the rinse with the enzymes carried over from the cleaning cycle. The cleaning composition preferably comprises a builder, a complexing agent, non-ionic surfactant, a dispersing polymer and optionally bleach.

Usually rinse aids in automatic dishwashing are used for finishing and not for cleaning of the dishware. Usually, rinse aids are used to promote sheeting of the rinse liquor to leave the cleaned dishware free of filming and spotting and shiny. In the present application it has been surprisingly found that a method comprising the step of treating the dishware with an enzymatic cleaning composition in the main wash followed by an alkaline rinse, provides improved cleaning, versus methods that do not include the step of an alkaline rinse. The method of the present invention provides improved enzymatic cleaning, more specially improved removal of proteinaceous soils while at the same time provides good shine and grit prevention. Shine is further improved when the rinse composition comprises a complexing agent, more in particular when the complexing agent comprises a salt of methyl glycine diacetic acid. The rinse composition is may be free of citric acid.

It has surprisingly been found that the when the maximum temperature of the rinse liquor is below 50° C. or about 45° C., filming and spotting on glass and plastic is reduced as compared to methods that use traditional rinse aid compositions containing acids. It has also surprisingly been found that the when the maximum temperature of the rinse liquor is below 50° C. or about 45° C., grit prevention on glass and plastic is greater than when using traditional rinse aid compositions containing acids.

In the context of the present application, “a dishwashing program” is a completed cleaning process that includes a cleaning cycle and a rinse cycle and optionally, pre-wash, pre-rinse and/or post-rinse cycles, and which can be selected and actuated by means of the program switch of the dishwasher. The duration of these separate dishwashing programs is advantageously at least 15 minutes, advantageously from 20 to 360 minutes or from 20 to 90 minutes. Within the meaning of this application, a “short cleaning program” lasts less than 60 minutes and a “long cleaning program” lasts 60 minutes or more.

A domestic dishwasher can usually provide a plurality of programs, such as a basic wash program, for washing normally dirty dishware dried up to a certain extent; an intensive wash program, for washing very dirty dishware; or in case of food rests particularly difficult to remove (very dry or burnt spots) an economy wash program. Each program comprises a plurality of sequential steps. Usually, one or two cold prewash cycles, a cleaning cycle (also known as main wash), a cold rinse cycle, a hot rinse cycle and optionally a drying cycle. During the different cycles of a program, different compositions can be added to the water in the dishwasher to help the cleaning.

During the course of a selected dishwashing program a domestic dishwasher generally performs more than one cycle, such as a pre-wash, cleaning cycle, intermediate rinse cycle, rinse cycle and then a drying cycle to terminate the program. During the respective cycles, wash liquor is distributed, in particular sprayed, by means of a rotating spray arm, a fixed spray nozzle, for example a top spray head, a movable spray nozzle, for example a top spinning unit, and/or some other liquid distribution apparatus, in the treatment chamber of the dishwasher cavity, in which wash liquor is applied to items to be washed, such as dishes and/or cutlery, which are supported in and/or on at least one loading unit, for example a pull-out rack or a cutlery drawer that can preferably be removed or pulled out. To this end the dishwasher is preferably supplied with wash liquor by way of at least one supply line by an operating circulating pump, said wash liquor collecting at the bottom of the dishwasher cavity, preferably in a depression, in particular in a sump. If the cleaning and/or the rinse liquors must be heated during the respective cycle, the wash and/or rinse liquor are heated by means of a heating facility. This can be part of the circulating pump. At the end of the respective cycle some or all of the liquor present in the treatment chamber of the dishwasher cavity in each instance might be pumped out by means of a drain pump.

### Cleaning Composition

The cleaning composition is delivered to the wash water of the cleaning cycle to form the wash liquor. The cleaning composition comprises enzymes, e.g. proteases and amylases. The wash liquor may be alkaline, and the wash liquor can have a pH above 9 or above 10. Preferably, the cleaning composition is free of phosphate. By “free of phosphate” is herein meant that the composition comprises less than 0.1% by weight of the composition of phosphate.

The cleaning composition comprises enzymes and optionally a complexing agent, a polymer, inorganic builder (preferably carbonate and/or silicate) non-ionic surfactant, etc. The composition may comprise bleach, bleach catalyst and/or bleach activators. In some embodiments the cleaning composition may be free of bleach, bleach catalyst and bleach activator and can be free of anionic surfactant.

### Enzymes

The cleaning composition comprises enzymes, e.g. amylases and proteases.

In describing enzyme variants herein, the following nomenclature is used for ease of reference: Original amino acid(s): position(s): substituted amino acid(s). Standard enzyme IUPAC 1-letter codes for amino acids are used.

### Proteases

The cleaning composition preferably comprises a protease. A mixture of two or more proteases can also contribute to an enhanced cleaning across a broader temperature, cycle duration, and/or substrate range, and provide superior shine benefits, especially when used in conjunction with an anti-redeposition agent and/or a sulfonated polymer.

Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include: (a) subtilisins (EC 3.4.21.62), especially those derived from Bacillus, such as Bacillus sp., B. lentus, B. alkalophilus, B. subtilis, B. amyloliquefaciens, B. pumilus, B. gibsonii, and B. akibaii described in WO2004067737, WO2015091989, WO2015091990, WO2015024739, WO2015143360, U.S. Pat. Nos. 6,312,936, 5,679,630, 4,760,025, DE102006022216A1, DE 102006022224A1, WO2015089447, WO2015089441, WO2016066756, WO2016066757, WO2016069557, WO2016069563, WO2016069569.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. described in WO2014194032, WO2014194054 and WO2014194117; from Kribella alluminosa described in WO2015193488; and from Streptomyces and Lysobacter described in WO2016075078.

(d) protease having at least 90% identity to the subtilase from Bacillus sp. TY 145, NCIMB 40339, described in WO92/17577 (Novozymes A/S), including the variants of this Bacillus sp TY145 subtilase described in WO2015024739, and WO2016066757.

(e) protease having at least 90% or at least 92% identity with the amino acid sequence of SEQ ID NO:85 from WO2016/205755 comprising at least one amino acid substitution (using the SEQ ID NO:85 numbering) selected from the group consisting of 1, 4, 9, 21, 24, 27, 36, 37, 39, 42, 43, 44, 47, 54, 55, 56, 74, 80, 85, 87, 99, 102, 114, 117, 119, 121, 126, 127, 128, 131, 143, 144, 158, 159, 160, 169, 182, 188, 190, 197, 198, 212, 224, 231, 232, 237, 242, 245, 246, 254, 255, 256, and 257, including the variants found in WO2016/205755 and WO2018/118950.

(f) protease having at least 90%, at least 92%, at least 98% identity with the amino acid sequence of SEQ ID NO:1 from U.S. Pat. No. 10,655,090 B2. A preferred protease has 100% identity with SEQ ID NO:1 from U.S. Pat. No. 10,655,090 B2. Another preferred protease has 1 to 4 modifications with respect to SEQ ID NO:1 from U.S. Pat. No. 10,655,090 B2.

Especially preferred proteases for the detergent of the invention are: (a) polypeptides demonstrating at least 90%, at least 95%, at least 98%, at least 99% or 100% identity with the wild-type enzyme from Bacillus lentus, comprising mutations in one or more, two or more or three or more of the following positions, using the BPN′ numbering system and amino acid abbreviations as illustrated in WO00/37627, which is incorporated herein by reference: V68A, N76D, N87S, S99D, S99AD, S99A, S101G, S101M, S103A, V104N/I, G118V, G118R, S128L, P129Q, S130A, Y167A, R1705, A194P, V2051, Q206L/D/E, Y209W and/or M222S. and/or (b) protease having at least 95%, at least 98%, at least 99% or 100% identity with the amino acid sequence of SEQ ID NO:85 from WO2016/205755 comprising at least one amino acid substitution (using the SEQ ID NO:85 numbering) selected from the group comprising: P54E/G/I/L/Q/S/TN; S99A/E/H/I/K/M/N/Q/R/T/V;S126A/D/E/F/G/H/I/L/M/N/Q/R/TN/Y; D127A/E/F/G/H/I/L/M/N/P/Q/S/TN/W/Y; F128A/C/D/E/G/H/I/K/L/M/N/P/Q/R/S/T/W, A37T, S39E, A47V, T56Y, 180V, N85S, E87D, T114Q, and N242D;

The additional protease may be either selected from the group of proteases comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

### (i) G118V+S128L+P129Q+S130A

### (ii) S101M+G118V+S128L+P129Q+S130A

(iii) N76D+N87R+G118R+S128L+P129Q+S130A+S188D+N248R

### (iv) N76D+N87R+G118R+S128L+P129Q+S130A+S188D+V244R

### (v) N76D+N87R+G118R+S128L+P129Q+S130A

### (vi) V68A+N87S+S101G+V104N

(vii) S99AD
or selected from the group of proteases comprising one or more, two or more, three or more, or four or more of the below mutations versus SEQ ID NO:1 from WO2018/118950:

### P54T, S99M, S126A/G, D127E, F128C/D/E/G, A37T, S39E, A47V, T56Y, 180V, N85S, E87D, T114Q, and N242D.

Most preferred for use herein are proteases wherein the protease is a variant having at least 60% identity with the amino acid sequence of SEQ ID NO:1 of WO2019/125894 A1 and comprising at least one amino acid substitution (using the SEQ ID NO: 1 numbering) selected from the group consisting of: X54T; X126A, D, G, V, E, K, I; X127E, S, T, A, P, G, C; and X128E, C, T, D, P, G, L, Y, N and X211L. Preferably, a variant having at least 90% identity with the amino acid sequence of SEQ ID NO:1 and said variant comprising at least one amino acid substitution (using the SEQ ID NO:1 numbering) selected from the group consisting of P54T, S126A, D127E, F128G and M211L.

Other preferred protease for use herein include a protease wherein the protease is a variant having at least 90% identity with the amino acid sequence of SEQ ID NO:1 of WO2019/245839 A1 and the variant comprises one or more amino acid substitutions at one or more positions corresponding to SEQ ID NO: 1 positions selected from: 1C/D/E/M/N, 21L, 37A, 54A, 73V, 76D/H/N/T, 83G, 84D/E/F, 851/M, 86I/S/TN, 87T, 88M/V, 89F/W, 911, 95A/N/S, 96M/Q, 97E, 98M, 99A/F/H/I/K/L/Q/T/W/Y, 102L, 104E, 105L, 1061/V, 108A, 1091, 112C, 114M/N, 115A/E/H/Q, 116A/E/G/H/Q, 118A/D/N, 122C, 124E/Q, 126I/Q/V, 128H/I/L/M/N/Q/S/T/V/Y, 129D/H, 130N, 131D/E/N/P/Q, 135A/D/H/K/L/M/N/Q/TN/W/Y, 138D/E, 139E/L, 141A/E/F/H/Y, 142A/D/E, 143E/H/K/M/S/V, 156E, and 157C/D/E wherein the amino acid positions of the variant are numbered by correspondence with the amino acid sequence of SEQ ID NO: 1.

Suitable commercially available additional protease enzymes include those sold under the trade names Alcalase®, Savinase®, Primase®, Durazym®, Polarzyme®, Kannase®, Liquanase®, Liquanase Ultra®, Savinase Ultra®, Savinase Evity®, Ovozyme®, Neutrase®, Everlase®, Coronase®, Blaze®, Blaze Ultra®, Blaze Evity® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase®, Extremase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101 R+S103A+V1041+G159S, hereinafter referred to as BLAP), BLAP R (BLAP with S3T+V4I+V199M+V2051+L217D), BLAP X (BLAP with S3T+V4I+V2051) and BLAP F49 (BLAP with S3T+V4I+A194P+V199M+V2051+L217D); and KAP (Bacillus alkalophilus subtilisin with mutations A230V+S256G+S259N) from Kao.

Especially preferred for use herein are commercial proteases selected from the group consisting of Properase®, Blaze®, Blaze Evity®, Savinase Evity®, Extremase®, Ultimase®, Everlase®, Savinase®, Excellase®, Blaze Ultra®, BLAP and BLAP variants.

Preferred levels of protease in the composition of the invention include from about 0.05 to about 20, from about 0.5 to about 15 or from about 2 to about 12 mg of active protease/g of composition.

### Amylases

Preferably the cleaning composition comprises an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCBI 12289, NCBI 12512, NCBI 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) variants described in WO 96/23873, WO00/60060, WO06/002643 and WO2017/192657, especially the variants with one or more substitutions in the following positions versus SEQ ID NO. 12 of WO06/002643: 26, 30, 33, 82, 37, 106, 118, 128, 133, 149, 150, 160, 178, 182, 186, 193, 202, 214, 231, 246, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D 183* and G184*.

(b) variants exhibiting at least 90% identity with SEQ ID No. 4 in WO06/002643, the wild-type enzyme from Bacillus SP722, especially variants with deletions in the 183 and 184 positions and variants described in WO 00/60060, WO2011/100410 and WO2013/003659 which are incorporated herein by reference.

(c) variants exhibiting at least 95% identity with the wild-type enzyme from Bacillus sp. 707 (SEQ ID NO:7 in U.S. Pat. No. 6,093,562), especially those comprising one or more of mutations in the following positions M202, M208, 5255, R172, and/or M261. Preferably said amylase comprises one or more of M202L, M202V, M2025, M202T, M202I, M202Q, M202W, S255N and/or R172Q. Particularly preferred are those comprising the M202L or M202T mutations.

(d) variants described in WO 09/149130, preferably those exhibiting at least 90% identity with SEQ ID NO: 1 or SEQ ID NO:2 in WO 09/149130, the wild-type enzyme from Geobacillus Stearophermophilus or a truncated version thereof.

(e) variants exhibiting at least 89% identity with SEQ ID NO:1 in WO2016091688, especially those comprising deletions at positions H183+G184 and additionally one or more mutations at positions 405, 421, 422 and/or 428.

(f) variants exhibiting at least 60% amino acid sequence identity with the “PcuAmyl a-amylase” from Paenibacillus curdlanolyticus YK9 (SEQ ID NO:3 in WO2014099523).

(g) variants exhibiting at least 60% amino acid sequence identity with the“CspAmy2 amylase” from Cytophaga sp. (SEQ ID NO:1 in WO2014164777).

(h) variants exhibiting at least 85% identity with AmyE from Bacillus subtilis (SEQ ID NO:1 in WO2009149271).

(i) variants exhibiting at least 90% identity with the wild-type amylase from Bacillus sp. KSM-K38 with accession number AB051102.

(j) variants exhibiting at least 80% identity with the mature amino acid sequence of AAI10 from Bacillus sp (SEQ ID NO:7 in WO2016180748), preferably comprising a mutation in one or more of the following positions modification in one or more positions 1, 54, 56, 72, 109, 113, 116, 134, 140, 159, 167, 169, 172, 173, 174, 181, 182, 183, 184, 189, 194, 195, 206, 255, 260, 262, 265, 284, 289, 304, 305, 347, 391, 395, 439, 469, 444, 473, 476, or 477

(k) variants exhibiting at least 80% identity with the mature amino acid sequence of the fusion peptide (SEQ ID NO:14 in US 2019/0169546), preferably comprising one or more of the mutations H1*, N54S+V56T, A60V, G109A, R116Q/H+W167F, L173V, A174S, Q172N, G182*, D183*, N195F, V206L/Y, V208L, K391A, K393A, I405L, A421H, A422P, A428T, G476K and/or G478K. Preferred amylases contain both the deletions G182* and G183* and optionally one or more of the following sets of mutations:

### 1. H1*+G109A+N195F+V206Y+K391A;

### 2. H1*+N54S+V56T+G109A+A1745+N195F+V206L+K391A+G476K)

### 3. H1*+N54S+V56T+A60V+G109A+R116Q+W167F+Q172N+L173V+A1745+N195F+V206L+I405L+A421H+A422P+A428T

### 4. H1*+N545+V56T+G109A+R116Q+A1745+N195F+V206L+I405L+A421H+A422P+A428T;

### 5. H1*+N545+V56T+G109A+R116H+A1745+N195F+V208L+K393A+G478K;

(l) variants exhibiting at least 80% identity with the mature amino acid sequence of Alicyclobacillus sp. amylase (SEQ ID NO:8 in WO2016180748).

The amylase can be an engineered enzyme, wherein one or more of the amino acids prone to bleach oxidation have been substituted by an amino acid less prone to oxidation. In particular it is preferred that methionine residues are substituted with any other amino acid. In particular it is preferred that the methionine most prone to oxidation is substituted. Preferably the methionine in a position equivalent to 202 in SEQ ID NO:2 is substituted. Preferably, the methionine at this position is substituted with threonine or leucine, preferably leucine.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL®, ATLANTIC®, INTENSA® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE®, PREFERENZ S® series (including PREFERENZ S1000® and PREFERENZ 52000® and PURASTAR OXAM® (DuPont., Palo Alto, Calif.) and KAM® (Kao, 14-10 Nihonbashi Kayabacho, 1-chome, Chuo-ku Tokyo 103-8210, Japan). In one aspect, suitable amylases include ATLANTIC®, STAINZYME®, POWERASE®, INTENSAO and STAINZYME PLUS®, ACHIEVE ALPHA® and mixtures thereof.

The composition of the invention may comprise at least 0.01 mg, from about 0.05 to about 10, from about 0.1 to about 6, or from about 0.2 to about 5 mg of active amylase/g of composition.

The protease and/or amylase of the composition of the invention may be in the form of granulates, and the granulates may comprise more than 29% of sodium sulfate by weight of the granulate and/or the sodium sulfate and the active enzyme (protease and/or amylase) are in a weight ratio of between 3:1 and 100:1, between 4:1 and 30:1, or between 5:1 and 20:1.

### Complexing Agent

Complexing agents are materials capable of sequestering hardness ions, particularly calcium and/or magnesium. The cleaning composition can comprise a high level of complexing agent, however the level should not be too high otherwise enzymes can be negatively affected. Too high level of complexing agent can also negatively impact on glass care. Complexing agents provide improved shine. Both the cleaning composition and the rinse composition may comprise complexing agents, especially a salt of methyl glycine diacetic acid.

The cleaning composition may comprise from 15% to 50%, from 20% to 40%, or from 20% to 35% by weight of the composition of a complexing agent selected from the group consisting of methylglycine-N,N-diacetic acid (MGDA), glutamic acid-N,N-diacetic acid (GLDA), iminodisuccinic acid (IDS), citric acid, aspartic acid -N,N-diacetic acid (ASDA) its salts and mixtures thereof. Especially preferred complexing agent for use herein is a salt of MGDA, in particular the trisodium salt of MGDA. Mixture of citrate and the trisodium salt of MGDA are also preferred for use herein. The cleaning composition of the invention may comprise from 15% to 40% by weight of the composition of the trisodium salt of MGDA.

### Inorganic Builder

The cleaning composition preferably comprises an inorganic builder. Suitable inorganic builders are selected from the group consisting of carbonate, silicate and mixtures thereof. Especially preferred for use herein are sodium carbonate and silicate. The cleaning composition may comprise from 5 to 50%, from 10 to 40% or from 15 to 30% of sodium carbonate by weight of the composition.

### Polymer

The polymer, if present, is used in any suitable amount from about 0.1% to about 30%, from 0.5% to about 15%, or from 1% to 10% by weight of the composition. Sulfonated/carboxylated polymers are particularly suitable for the composition.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, or from about 5,000 Da to about 45,000 Da.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

The polymer may comprise the following levels of monomers: from about 40 to about 90%, or from about 60 to about 90% by weight of the polymer of one or more carboxylic acid monomer; from about 5 to about 50%, or from about 10 to about 40% by weight of the polymer of one or more sulfonic acid monomer; and optionally from about 1% to about 30%, or from about 2 to about 20% by weight of the polymer of one or more non-ionic monomer. An exemplary polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, e.g. alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercially available polymers include: Alcosperse 240 and Aquatreat AR 540 supplied by Nouryon; Acumer 3100, Acumer 2000, Acusol 587G and Acusol 588G supplied by Dow. Particularly preferred polymers are Acusol 587G and Acusol 588G supplied by Dow.

Suitable polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol or from about 5,000 to about 45,000 g/mol. The dispersant polymer may be a low molecular weight homopolymer of polyacrylate, with an average molecular weight of from 1,000 to 20,000, from 2,000 to 10,000, or from 3,000 to 5,000.

The polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000, from 20,000 to 50,000 or 30,000 to 40,000 g/mol. and a ratio of (meth)acrylate to maleate or fumarate segments of from 30:1 to 1:2.

The polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such polymer may have a molecular weight of from 4,000 to 20,000 and an acrylamide content of from 0% to 15%, by weight of the polymer.

Polymers suitable herein also include itaconic acid homopolymers and copolymers.

Alternatively, the polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

### Nonionic Surfactant

Surfactants suitable for use herein include non-ionic surfactants. The compositions may be free of any other surfactants, or the compositions may be free of anionic cleaning surfactants. Anionic cleaning surfactants are typically detergency grade having a chain length of more than 10 carbon atoms. Anionic cleaning surfactants include alkyl sulfates, alkyl/aryl sulfonates and alkyl ethoxysulfates. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the cleaning composition comprises a non-ionic surfactant or a non-ionic surfactant system. The non-ionic surfactant or a non-ionic surfactant system can have a cloud point, as measured at a concentration of 1% in distilled water, between 20 and 70° C., or between 35 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

The cloud point is the temperature at which a non-ionic surfactant solution phase separates into a water rich and surfactant rich phase and becomes cloudy. The cloud point temperature can be determined visually by identifying at which temperature cloudiness occurs.

The cloud point temperature of a non-ionic surfactant can be determined as follows: a solution containing 1% of the corresponding non-ionic surfactant by weight of the solution is prepared in distilled water. The solution is stirred gently before analysis to ensure that the process occurs in chemical equilibrium. The cloud point temperature is taken in a thermostatic bath by immersing the surfactant solution in a 75 mm sealed glass test tube. To ensure the absence of leakage, the test tube is weighed before and after the cloud point temperature measurement. The temperature is gradually increased at a rate of less than 1° C. per minute, until the temperature reaches a few degrees below the pre-estimated cloud point. The cloud point temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with at least 3 moles, at least 5 moles, or at least 7 moles of ethylene oxide per mole of alcohol or alkylphenol; ii) alcohol alkoxylated surfactants having from 6 to 20 carbon atoms and at least one ethoxy and propoxy group. Preferred for use herein are mixtures of surfactants i) and ii).

Other suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5 or about 1; and y is an integer having a value of at least 15 or at least 20.

The surfactant of formula I, may comprise at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the cleaning composition of the invention. Preferred are C10-C18 alkyl dimethylamine oxide, and C10-18 acylamido alkyl dimethylamine oxide.

The cleaning composition may comprise from about 0.1 to about 30% by weight of the composition or from about 0.5 to about 20% by weight of the composition of non-ionic surfactants.

### Crystal Growth Inhibitor

Crystal growth inhibitors are materials that can bind to calcium carbonate crystals and prevent further growth of species such as aragonite and calcite.

Especially preferred crystal growth inhibitor for use herein is a sodium salt of HEDP (1-hydroxyethylidene 1,1-diphosphonic acid). The cleaning composition may comprise from 0.01 to 10%, from 0.1 to 8% or from 0.5 to 6% of a crystal growth inhibitor by weight of the composition, e.g. a sodium salt of HEDP.

### Metal Care Agents

Metal care agents may prevent or reduce the tarnishing, corrosion or oxidation of metals, including aluminium, stainless steel and non-ferrous metals, such as silver and copper. The cleaning composition may comprise from 0.1 to 5%, from 0.2 to 4% or from 0.3 to 3% by weight of the composition of a metal care agent, e.g. benzo triazole (BTA).

### Glass Care Agents

Glass care agents protect the appearance of glass items during the dishwashing process. The cleaning composition may comprise from 0.1 to 5%, from 0.2 to 4% or from 0.3 to 3% by weight of the composition of a glass care agent, e.g. a zinc salt.

### Bleach

In some embodiments the composition may comprises from about 8 to about 30%, from about 9 to about 25%, or from about 9 to about 20% of bleach by weight of the composition.

Inorganic and organic bleaches are suitable for use herein. Inorganic bleaches include perhydrate salts such as perborate, percarbonate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate may be incorporated into the products in a coated form which provides in-product stability.

Potassium peroxymonopersulfate is another inorganic perhydrate salt of utility herein.

Typical organic bleaches are organic peroxyacids, especially dodecanediperoxoic acid, tetradecanediperoxoic acid, and hexadecanediperoxoic acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for some embodiments include compounds which, under perhydrolysis conditions, give aliphatic peroxoycarboxylic acids having from 1 to 12 carbon atoms, from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the cleaning composition comprises from 0.01 to 5 or from 0.2 to 2% by weight of the composition of bleach activator, e.g. TAED.

### Bleach Catalyst

The cleaning composition may comprise a bleach catalyst, e.g. a metal containing bleach catalyst. The metal containing bleach catalyst may be a transition metal containing bleach catalyst, e.g. a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt (III) and related complexes.

The cleaning composition may comprise from 0.001 to 0.5 or from 0.002 to 0.05% of bleach catalyst by weight of the composition. Preferably the bleach catalyst is a manganese bleach catalyst.

The cleaning composition of the invention may comprise:
i) from 5 to 50% by weight of the composition of a builder;
ii) from 0.5 to 20% by weight of the composition of non-ionic surfactant;
iii) from 5 to 50% by weight of the composition of a complexing agent, wherein the complexing agent comprises a salt of MGDA;
iv) enzymes, wherein the enzymes comprise an amylase and a protease;
v) optionally from 0.5 to 10% by weight of the composition of a dispersant polymer, wherein the dispersant polymer comprises a carboxylate/sulfonate polymer;
vi) optionally from 5 to 20% by weight of the composition of bleach and/or a bleach catalyst;

### Rinse Composition

The rinse composition is delivered to the water of the rinse cycle to form the rinse liquor. The rinse liquor can have a pH above 9, above 10, or above 10.2. The rinse composition is free of enzymes. By “free of” is herein meant that the composition comprises less than 0.1% or less than 0.001% by weight of the composition of enzymes.

The rinse composition may comprise any of the ingredients listed in the description of the cleaning composition, except enzymes, at same levels, unless specified otherwise.

The rinse composition preferably comprises an alkalinity source. Alkalinity sources include carbonate, silicates and alkali metal hydroxides. The alkalinity source may comprise an alkali metal hydroxide, e.g. sodium hydroxide. Other alkalinity sources may have a negative impact on shine of the dishware, specially shine of glass.

The rinse composition may also comprise a complexing agent. Improved shine and improved removal of bleachable stains is obtained when the rinse composition comprises a complexing agent, in particular when the rinse composition comprises a salt of methyl glycine diacetic acid. The rinse composition may comprise from 5 to 50%, from 10 to 35% by weight of the composition of a complexing agent. The rinse composition may be free of citric acid.

The rinse composition preferably comprises a crystal growth inhibitor, e.g. a sodium salt of HEDP. The rinse composition may comprise from 0.1 to 30%, from 0.5 to 25% or from 1 to 20% of a crystal growth inhibitor by weight of the composition.

The rinse composition may comprise from 5 to 50% or from 10 to 40% by weight of the composition of a non-ionic surfactant. The rinse composition may be free of anionic cleaning surfactants. By “anionic cleaning surfactant” is herein meant an anionic surfactant having a chain length of more than 10 carbon atoms. Examples of anionic cleaning surfactants include long chain length (i.e., more than 10 carbon atoms) alkyl sulfates, alkyl/aryl sulfonates and alkyl ethoxysulfates.

### Hydrotropes

The rinse aid composition of the present invention can include a hydrotrope. A hydrotrope creates increased water solubility of hydrophobic materials and ensures physical stability of the composition. In some embodiments, hydrotropes are low molecular weight aromatic sulfonate materials such as cumene sulfonate, xylene sulfonate and dialkyldiphenyl oxide sulfonate materials. In other embodiments, hydrotropes are short chainlength alkyl sulfates with less than 10 carbon atoms in the alkyl chain.

A hydrotrope or combination of hydrotropes can be present in the compositions at an amount of from between about 1% to about 50% by weight of the composition. In other embodiments, a hydrotrope or combination of hydrotropes can be present at about 10% to about 30% by weight of the composition.

### Carriers

The rinse composition of the present invention can be formulated as liquid compositions. Carriers can be included in such liquid formulations. Any carrier suitable for use in a rinse aid composition can be used in the present invention. For example, in some embodiments the compositions include water as a carrier.

In some embodiments, liquid rinse aid compositions according to the present invention will contain no more than about 98% by weight of the composition of water and typically no more than about 90% by weight of the composition of water. In other embodiments, liquid rinse aid compositions will contain at least 50% by weight of the composition of water, or at least 60% by weight of the composition of water as a carrier.

The rinse composition may comprise glass care and/or metal care agents.

The rinse composition of the method of the invention may comprise:
i) from 0 to 40% by weight of the composition of an alkalinity source;
ii) from 10 to 40% by weight of the composition of non-ionic surfactant;
iii) from 10 to 35% by weight of the composition of a complexing agent, wherein the complexing agent comprises a salt of MGDA;
iv) from 0 to 20% by weight of the composition of a sodium salt of HEDP;
v) optionally a glass care and/or a metal care agent; and
vi) water;
Pack to house the cleaning and the rinse composition.

The cleaning and the rinse composition may be housed in a pack comprising at least two separate compartments. The pack can have more than two compartments. The pack can be inserted into the dishwasher as such or its content can be used to fill existing storing reservoirs in the dishwasher.

The pack or reservoir containing the compositions of the method of the invention can be located inside or outside of the dishwasher. If placed inside of the dishwasher, the pack or storage reservoir can be integrated into the automatic dishwasher (i.e., a storage reservoir permanently fixed (built in) to the automatic dishwasher), and can also be autarkic (i.e., an independent storage reservoir that can be inserted into the interior of the automatic dishwasher).

An example of an integrated storage reservoir is a receptacle built into the door of the automatic dishwasher and connected to the interior of the dishwasher by a supply line.

The pack can be used as a removable dosing device. The dosing device can be for example an automated unit comprising the pack and a dispensing unit capable of releasing a controlled amount of different compositions at different times, for example to the main wash and to the rinse. Different types of hardware might be part of the dosing device for controlling the dispensing of the cleaning and rinsing compositions, or for communicating with external devices such as data processing units, the dishwasher or a mobile device or server that a user can operate.

The pack has very good thermal stability, especially if it is to be located in the interior of the dishwasher.

From 1 to 25 or from 2 to 20 grams of the cleaning composition may be delivered first, followed by from 1 to 15 or from 2 to 8 grams of the rinse composition thereafter.

Preferred processes according to the invention are those wherein the compositions, prior to being metered into the interior of the dishwasher, remains in the storage reservoir that is located outside (as for example WO2019/81910A1) or inside of the dishwasher for at least two, at least four, at least eight or at least twelve separate dishwashing programs.

The dosing system can be linked to sensors that can determine, based on sensor's input, the amount of composition required. Sensors that may be used include pH, turbidity, temperature, humidity, conductivity, etc. The dishwasher may require data processing power to achieve this. It is preferred that the dishwashing will have connectivity to other devices. This may take the form of wi-fi, mobile data, blue tooth, etc. This may allow the dishwasher to be monitored and/or controlled remotely. Preferably, this also allows the machine to connect with the internet.

The volume of preferred storage reservoirs containing one or more chambers is from 10 to 1000 ml, from 20 to 800 ml, or from 50 to 500 ml.

### EXAMPLES

Automatic dishwashing compositions were made as detailed herein below.

### I. Preparation of Test Compositions

Cleaning composition: 13.34 grams of an automatic dishwashing detergent (based on active ingredients) comprising MGDA, bleach, bleach catalyst, carbonate, HEDP, sulfonated polymer, protease, amylase and non-ionic surfactant.

Four rinse compositions were prepared as detailed below:

| Rinse composition | 1 | 2 | 3 |
|---|---|---|---|
| Ingredient | Level (grams active per dose) | | |
| Citric acid | 0.07 | | |
| MGDA (Tri-sodium | | 2.5 | 2.5 |
| salt of methyl | | | |
| glycine diacetic acid) | | | |
| NaOH | | 0.9 | 0.9 |
| Plurafac ® RA300 | 1 | 1 | |
| (non-ionic surfactant | | | |
| supplied by BASF) | | | |
| Plurafac ® SLF180 | | | 0.75 |
| (non-ionic surfactant | | | |
| supplied by BASF) | | | |
| Marlipal ® O13/70 | | | 0.25 |
| (non-ionic surfactant | | | |
| supplied by Sasol) | | | |
| pH in the rinse | 7.3 | 10.5 | 10.5 |
| TOTAL g active | 1.07 | 4.4 | 4.4 |

### II. Test Items

The following items were sourced and added to each automatic dishwasher

| | | | Number of |
|---|---|---|---|
| | | | Replicates |
| | | | added and |
| | | | position in |
| Test Item | Supplier | Description | machine |
| Dallas Glass | Muller | Article number | 2 |
| | NV | 802002 | top rack |
| Plastic SAN tumbler | US | Article number | 2 |
| | Acrylic | 9273 | top rack |

Dishwasher monitors were purchased from Center for Testmaterials B. V. Netherlands. The following stains were used

| Code | Stain |
|---|---|
| DM25 | Boiled Egg Yolk |
| DM32 | Egg Yolk with Milk, double soiled load |
| DM92 | Minced meat, double soiled load |

### III. Additional Ballast Soil I

To add extra soil stress to the test, a blend of soils is added to the dishwasher, as prepared by the procedure described below:

| | % |
|---|---|
| Ingredient | content |
| Vegetable oil | 31.6 |
| Margarine | 6.3 |
| Lard | 6.3 |
| Deep-frying fat | 6.3 |
| Whole egg | 15.8 |
| Cream | 9.4 |
| Whole Milk | 6.3 |
| Potato Starch | 2.2 |
| Gravy | 1.7 |
| Wheat Flour | 0.6 |
| Quark Powder | 0.6 |
| Benzoic Acid >99% | 0.3 |
| Tomato Ketchup | 6.3 |
| Mustard | 6.3 |
| Total | 100 |

### Soil Preparation

1. Combine the vegetable oil and whole egg and mix thoroughly (approximately 30 minutes).

2. Add ketchup and mustard, still stirring vigorously.

3. Melt the fats, allow to cool to approximately 40° C., then add to the mixture and blend well.

4. Stir in the cream and milk.

5. Add the powdered solid constituents and mix everything to a smooth paste.

6. Put 50 g of the soil mix into plastic pots and freeze.

### IV. Additional Ballast Soil II

To add extra soil stress to the test, a blend of soils is added to the dishwasher, as prepared by the procedure described below:

| | % |
|---|---|
| Ingredient | content |
| Carrefour Matière grass | 49.95 |
| végétale (Cuir et Rotir) | |
| Carrefour Graisse à frire | 49.95 |
| Solvent Red 26 dye | 0.1 |

### Soil Preparation

1. Mix the Carrefour Matière grass végétale (Cuir et Rotir) and Carrefour Graisse à frire in a Thermomixer for 30 minutes at speed 2, 55° C. to melt the grease while mixing.
2. After 30 minutes add the Solvent Red 26 dye to the mixture and continue the mixing for another 15 minutes on the same settings.
3. Put 10 g of the soil mixture into plastic pots and refrigerate.
   V Test wash procedure
Automatic Dishwasher: Miele, model GSL2
Wash volume: 5000 ml
Main Wash Water temperature: 45° C.
Length of the Main Wash 22 minutes (8 minutes holding)
Rinse Water temperature: 45° C., 55° C. or 70° C.
Water hardness: 21 gpg
Cleaning composition addition: Added into the bottom of the automatic dishwasher when the detergent dispenser opens at the start of the main wash.
Rinse composition addition: Added into the bottom of the automatic dishwasher at the start of second (heated) rinse.
Additional soil stress: 1× 50 g pot of additional ballast soil I and 1× 10 g pot of additional ballast soil II added to bottom rack.

### Examples 1-3

13.34 grams of the cleaning composition were added to the main wash, the amount detailed in the table below were added to the rinse.

| | Cleaning | |
|---|---|---|
| | composition | Rinse composition |
| Method 1 | 13.34 g | None added |
| Method 2 | 13.34 g | 1.07 g Composition 1 |
| Method 3 | 13.34 g | 4.4 g Composition 2 |
| Method 4 | 13.34 g | 4.4 g Composition 3 |

A dishwasher was loaded with the dishwasher monitors as detailed above which were washed using Methods 1 to 4. The methods were repeated 4 times, giving 4 replicates for each of the stains tested. The stains were analysed before and washing via Image Analysis System to measure % stain removed, and stain removal index (SRI) was calculated. SRI is a 0-100 scale with 0=no stain removal and 100=full removal of the soil. Averages calculated and shown herein. Significances are calculated with a statistical package at 95% confidence.

| Example 1 | Method 1 | Method 2 | Method 3 | Method 4 |
|---|---|---|---|---|
| Rinse Temperature | 45° C. | | | |
| DM25 Boiled Egg | 85.09 | 86.07 | 84.44 | 84.06 |
| Yolk | | | | |
| DM32 Double Egg | 43.26 | 45.34 | 61.58 | 60.37 |
| Yolk with Milk | | | Significant | Significant |
| | | | vs A and B | vs A and B |
| DM92 Double | 82.88 | 85.57 | 88.84 | 87.83 |
| Minced Meat | | | Significant | Significant |
| | | | vs A and B | vs A |
| Example 2 | Method 1 | Method 2 | Method 3 | Method 4 |
| Rinse Temperature | 55° C. | | | |
| DM25 Boiled Egg | 77.26 | 70.42 | 80.46 | 79.35 |
| Yolk | | | Significant | Significant |
| | | | vs B | vs B |
| DM32 Double Egg | 41.75 | 46.07 | 62.31 | 60.74 |
| Yolk with Milk | | | Significant | Significant |
| | | | vs A and B | vs A and B |
| DM92 Double | 75.69 | 77.96 | 84.87 | 83.31 |
| Minced Meat | | | Significant | Significant |
| | | | vs A and B | vs A and B |
| Example 3 | Method 1 | Method 2 | Method 3 | Method 4 |
| Rinse Temperature | 70° C. | | | |
| DM25 Boiled Egg | 80.88 | 69.78 | 83.92 | 81.31 |
| Yolk | | | | |
| DM32 Double Egg | 75.78 | 78.58 | 85.98 | 83.43 |
| Yolk with Milk | | | Significant | Significant |
| | | | vs A and B | vs A and B |
| DM92 Double | 41.61 | 49.09 | 63.29 | 59.94 |
| Minced Meat | | | Significant | Significant |
| | | | vs A and B | vs A and B |

### Example 4

13.34 grams of the cleaning composition were added to the main wash, the amount detailed in the table below were added to the rinse.

| | Cleaning | |
|---|---|---|
| Example | composition | Rinse composition |
| Method 2 | 13.34 g | 1.07 g Composition 1 |
| Method 3 | 13.34 g | 4.4 g Composition 2 |

A dishwasher was loaded with the items as detailed above which were washed using Method 2 and Method 3, respectively. After running 4 consecutive cycles, the plastic tumblers were then photographed against a black background and the images were analysed using computer aided software. The image produced is analysed versus the greyscale and assigned a number to indicate the average transmission of light through the same. The whiter the image, the lower the transmission of light through the sample, the blacker the image, the higher the transmission of light through the sample. The number is converted to a percentage scale and called % Clarity. A clarity difference of 2 is significant.

% clarity=100−((Average Grey Scale Value/255)*100)

A spot is defined as a circular cluster larger than 4 pixels with higher gray scale (4 units) versus the background, while grit is defined as a circular cluster smaller than 4 pixels with higher gray scale (4 units) versus the background.

| | Rinse Temperature 45° C. | | | | | |
|---|---|---|---|---|---|---|
| Item | Dallas Glass | | | Plastic SAN tumbler | | |
| Example 4 | Clarity | Spot | Grit | Clarity | Spot | Grit |
| | (%) | Count | Count | (%) | Count | Count |
| Method 2 | 88.5 | 6.0 | 98.5 | 82.8 | 422 | 1625 |
| Method 3 | 91.1 | 5.0 | 59.5 | 88.2 | 221 | 951 |

The method of the invention provides improved clarity and reduced spot and grit count on both, glass and plastic.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of cleaning dishware in a domestic dishwasher using a program comprising a cleaning cycle and a rinse cycle, the method comprising the steps of:
a) placing the dishware in the dishwasher;
b) delivering a cleaning composition comprising enzymes into the cleaning cycle to form a wash liquor and subjecting the dishware to the wash liquor; and
c) delivering a rinse composition free of enzymes and free of bleach into the rinse cycle to form a rinse liquor having a pH of greater than about 9 and subjecting the dishware to the rinse liquor.

2. A method according to claim 1, wherein the cleaning composition comprises proteases and amylases.

3. A method according to claim 1, wherein the wash liquor has a pH of greater than about 9.

4. A method according to claim 1 wherein the rinse composition comprises an alkali metal hydroxide.

5. A method according to claim 1, wherein the rinse composition comprises a complexing agent.

6. A method according to claim 1, wherein the rinse composition comprises a non-ionic surfactant.

7. A method according to claim 1, wherein the rinse composition comprises a salt of methyl glycine diacetic acid and a non-ionic surfactant.

8. A method according to claim 1, wherein the maximum temperature of the rinse liquor is below about 50° C.

9. A method according to claim 1, wherein the method comprises an intermediate rinse step between steps b) and c).

10. A method according to claim 1, wherein the method comprises a further rinse step after step c).

11. A method according to claim 1 wherein the compositions are delivered from a multi-dosing system.

12. An automatic dishwashing pack suitable for use in the method according to claim 1, the pack comprising at least two different compartments, a first compartment comprising the cleaning composition and a second compartment comprising the rinse composition.

13. A method according to claim 5, wherein the complexing agent comprises a salt of methyl glycine diacetic acid.
